(19) United States
(12) Patent Application Publication
(10) Pub. No.: US 2013/0128601 A1
(43) Pub. Date: May 23, 2013

(54) INTEGRATED LAMP DEVICE OF VEHICLE SIDE MIRROR

(71) Applicant: SL Corporation, Daegu (KR)

(72) Inventors: Yong Hwan Kim, Gyeongsan (KR); Gi Man Park, Gyeongsan (KR)

(73) Assignee: SL CORPORATION, Daegu (KR)

(21) Appl. No.: 13/679,517

(22) Filed: Nov. 16, 2012

(30) Foreign Application Priority Data
Nov. 18, 2011 (KR) 10-2011-0121181

(51) Int. Cl. B60Q 1/26; F21V 8/00; B60R 1/00

(52) U.S. Cl. CPC B60Q 1/2607; B60R 1/006; G02B 6/0001
USPC 362/511; 362/543; 362/540

(57) ABSTRACT

Provided herein is an integrated lamp device of a vehicle side mirror. The integrated lamp device includes a first light source illuminating a first direction; a second light source illuminating a second direction; and a printed circuit board (PCB) assembly including a first PCB on which the first light source is mounted and a second PCB on which the second light source is mounted, wherein the first PCB and the second PCB are integrated with each other.

### CROSS-REFERENCE TO RELATED APPLICATIONS

This application claims priority from Korean Patent Application No. 10-2011-0121181 filed on Nov. 18, 2011, the entire contents of which are incorporated herein by reference.

### BACKGROUND OF THE INVENTION

1. Field of the Invention

The present invention relates to an integrated lamp device of a vehicle side mirror, and more particularly, to a structure that enables a position lamp, a backup lamp, a puddle lamp and, in some cases, a turn signal lamp to all be installed in one vehicle side minor.

2. Description of the Related Art

A vehicle side mirror is a reflector installed on the driver side door and the passenger side door to help a driver see an area behind a vehicle. The side mirror may also called a door mirror. The side mirror may be designed more freely than a fender mirror installed in the fenders on the front of the vehicle. Therefore, various technologies are being applied to the side minor to increase driver convenience.

A lighting device may also be installed in the side mirror. In addition to a turn signal lamp for providing information about the turning direction of a vehicle, a position lamp may be installed for providing information about the presence and width of the vehicle to other drivers at night or in weather conditions such as fog and rain.

Further, in current development is a device which captures images of areas around a vehicle using cameras installed on the front, rear, left and right sides of the vehicle, combines the captured images, and displays the combined images on a display installed in the vehicle. To this end, auxiliary lamps may be installed to illuminate areas behind and to the sides of the vehicle, so that the areas around the vehicle may be photographed with substantially minimal difficulty even under dark (low luminance) lighting conditions. These auxiliary lamps may also be installed in the side mirror.

### SUMMARY OF THE INVENTION

Accordingly, the present invention provides an integrated lamp device of a vehicle side mirror, the integrated lamp device including various types of lamps used for various purposes.

However, aspects of the present invention are not restricted to the one set forth herein. The above and other aspects of the present invention will become more apparent to one of ordinary skill in the art to which the present invention pertains by referencing the description of exemplary embodiments given below.

According to an aspect of the present invention, an integrated lamp device of a vehicle side mirror, includes a first light source illuminating a first direction; a second light source illuminating a second direction; and a printed circuit board (PCB) assembly including a first PCB on which the first light source may be mounted and a second PCB on which the second light source may be mounted, wherein the first PCB and the second PCB may be integrated with each other.

The integrated lamp device may further include a third light source illuminating a third direction; and a fourth light source illuminating a fourth direction, wherein the third light source may be mounted on a third PCB, the fourth light source may be mounted on a fourth PCB, and the PCB assembly may include the first through fourth PCBs integrated with each other.

According to another aspect of the present invention, an integrated lamp device of a vehicle side mirror includes a first light source illuminating a first direction; a second light source illuminating a second direction; a PCB assembly comprising a first PCB on which the first light source may be mounted and a second PCB on which the second light source may be mounted; and a light guide which may receive light from at least one of the first and second light sources through an end thereof, wherein the first PCB and the second PCB may be integrated with each other.

### BRIEF DESCRIPTION OF THE DRAWINGS

The above and other objects, advantages and features of the present invention will now be more clearly understood from the following detailed description taken in conjunction with the accompanying drawings, in which:

FIG. 1 is an exemplary front view of a vehicle side mirror using an integrated lamp device, according to an exemplary embodiment of the present invention;

FIG. 2 is an exemplary internal front view of the side mirror of FIG. 1 without a front frame and a minor, according to an exemplary embodiment of the present invention;

FIG. 3 is an exemplary enlarged side view of a portion ‘A’ of FIG. 2 illustrated from a left side, according to an exemplary embodiment of the present invention;

FIG. 4 is an exemplary side view of FIG. 3 without a side mirror frame, according to an exemplary embodiment of the present invention;

FIG. 5 is an exemplary rear view of FIG. 4, according to an exemplary embodiment of the present invention;

FIG. 6 is an exemplary side view of FIG. 4 without a turn signal light guide, according to an exemplary embodiment of the present invention;

FIG. 7 illustrates the vehicle side mirror illuminated by the integrated lamp device, according to an exemplary embodiment of the present invention;

FIG. 8 is an exemplary front view of a vehicle side mirror using an integrated lamp device, according to an exemplary embodiment of the present invention;

FIG. 9 is an exemplary internal front view of the side mirror of FIG. 8 without a front frame and a minor, according to an exemplary embodiment of the present invention;

FIG. 10 is an exemplary enlarged side view of a portion ‘B’ of FIG. 9, according to an exemplary embodiment of the present invention; and

FIG. 11 is an exemplary enlarged side view of a portion ‘C’ of FIG. 9, according to an exemplary embodiment of the present invention.

### DESCRIPTION OF EMBODIMENTS

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Advantages, objects and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided for this disclosure to be thorough and complete and will fully convey the concept of the invention to those skilled in the art, and the present invention will only be defined by the appended claims. Like reference numerals refer to like elements throughout the specification.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

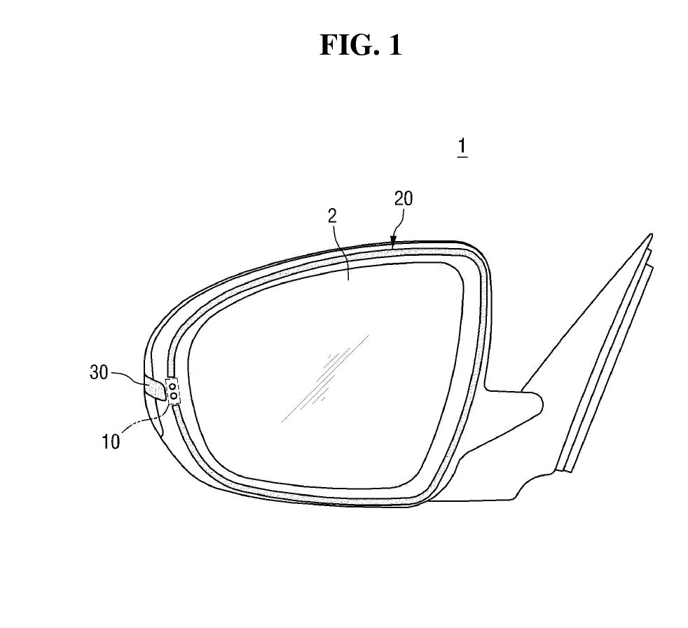

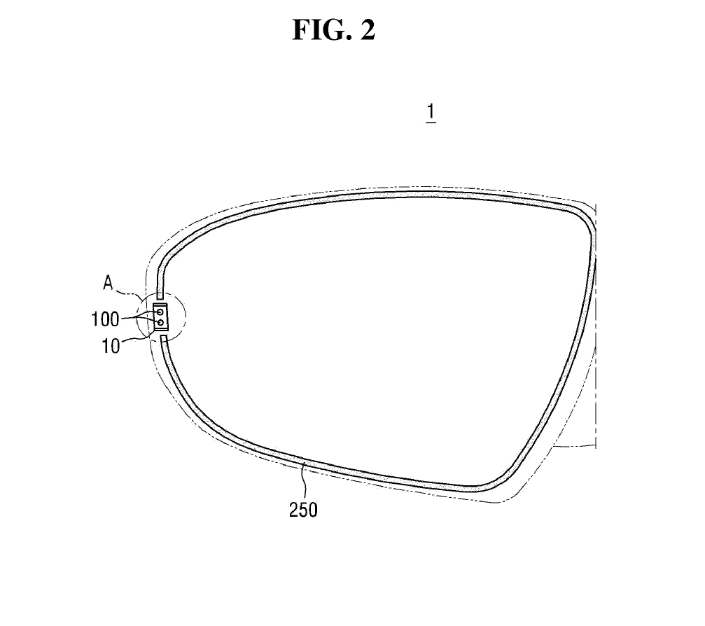

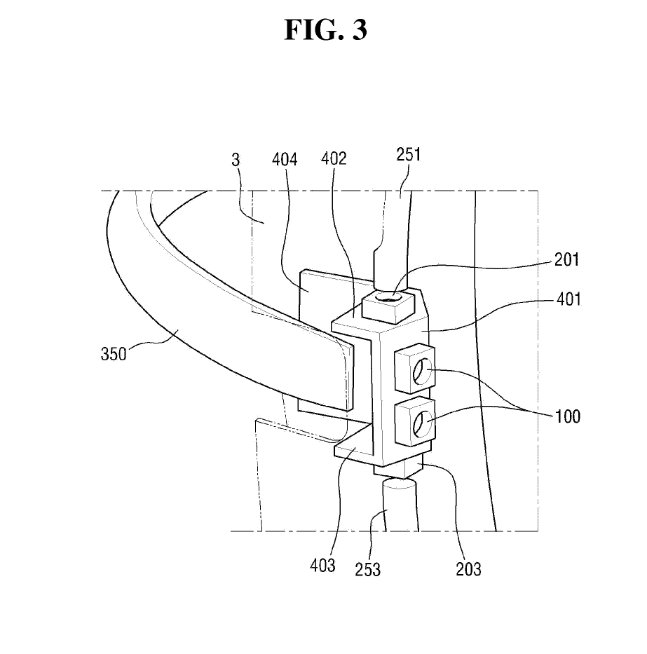

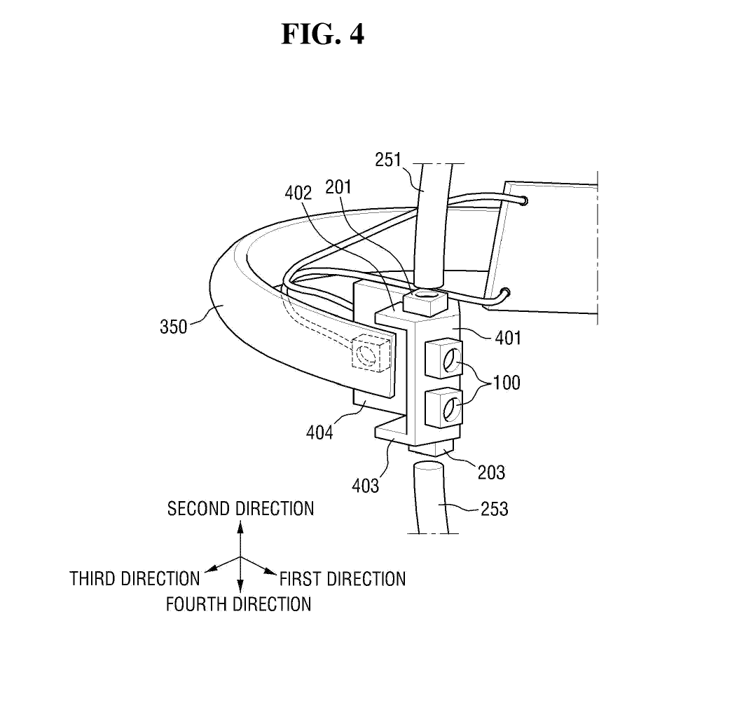

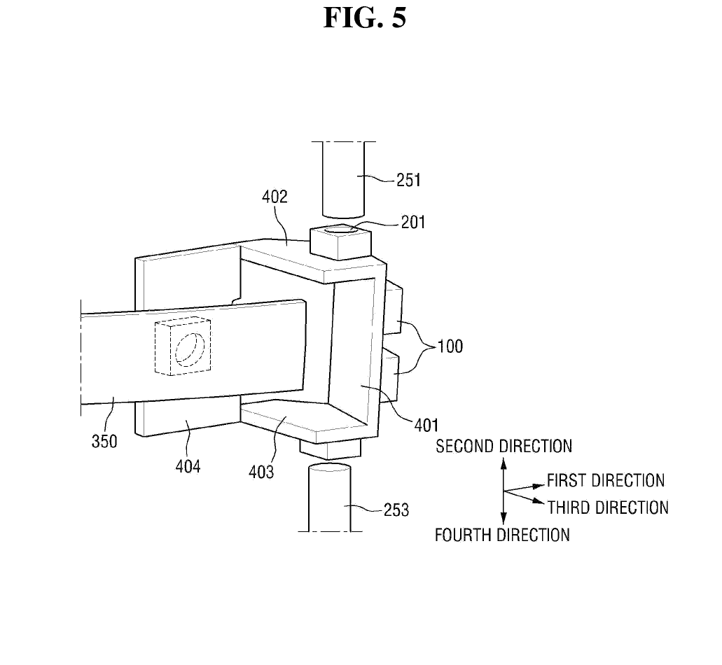

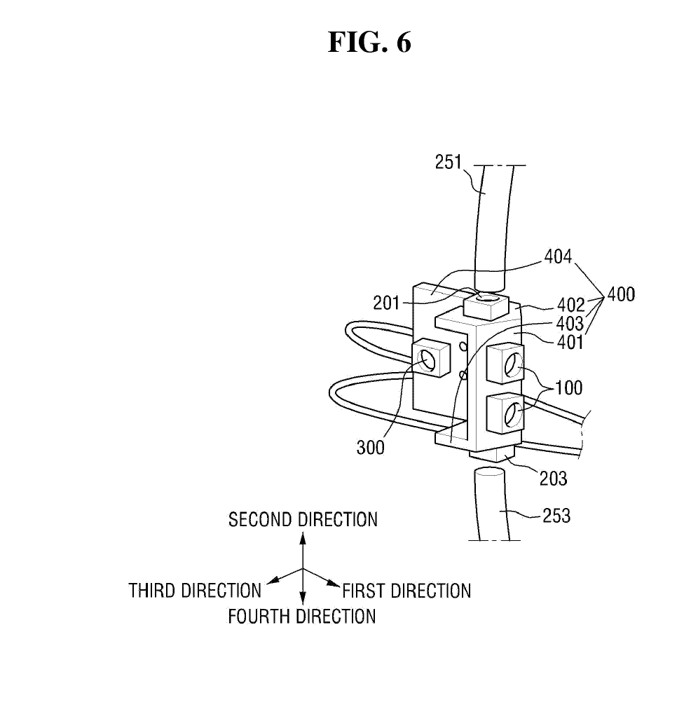

FIG. 1 is an exemplary front view of a vehicle side mirror 1 using an integrated lamp device;. FIG. 2 is an exemplary internal front view of the side mirror 1 of FIG. 1 without a front frame and a mirror; and FIG. 3 is an exemplary enlarged side view of a portion ‘A’ of FIG. 2 seen from the left side. FIG. 4 is an exemplary side view of FIG. 3 without a side minor frame; FIG. 5 is an exemplary rear view of FIG. 4; and FIG. 6 is an exemplary side view of FIG. 4 without a turn signal light guide 350.

Referring to FIG. 6, the integrated lamp device of the vehicle side mirror 1 according to the current embodiment, includes backup lamp light sources 100, a first position lamp light source 201, a second position lamp light source 203, a turn signal lamp light source 300, and a printed circuit board (PCB) assembly 400.

A light source may be an object or tool which emits light. Various types of light sources may be used, but embodiments in which a light-emitting diode (LED) is used will be described in the present specification. Therefore, the term ‘light source’ will hereinafter be replaced with the term ‘LED’ for ease of description and understanding.

FIG. 6 is merely an embodiment suggested in the present invention, and the above light sources may be replaced with a light source for a different use. For example, the above light sources may be replaced with a puddle lamp light source. A puddle lamp may illuminate the ground while flickering when a driver locks or unlocks a door lock of a vehicle using a remote control or when the driver opens or closes a door using a smart key. A puddle lamp light source may generally be installed on the bottom of a minor housing or a rocker panel to emit light toward the ground. The puddle lamp light source may be one of the light sources suggested in FIG. 6.

The backup lamp LEDs 100 enable a backup lamp 10 of the side minor 1 to emit light from the left and right sides of a vehicle toward the rear of the vehicle. In FIGS. 1 through 7, two backup lamp LEDs are used. However, the number of backup lamp LEDs is not limited. The backup lamp LEDs 100 may emit light in a direction toward the rear of the vehicle. For ease of description, this direction will be referred to as a first direction.

The first position lamp LED 201 and the second position lamp LED 203 may be designed to illuminate a position lamp 20 of the side minor 1. In FIGS. 1 through 7, one first position lamp LED and one second position lamp LED may be used. However, the number of first position lamp LEDs and the number of second position lamp LEDs are not limited. Furthermore, when one position light guide 250 is used as shown in FIG. 2, either one or two position lamp LEDs may be used, and this embodiment is included in the scope of the present invention.

Moreover, an embodiment including both the first position lamp LED 201 and the second position lamp LED 203 are used will be described below.

The first position lamp LED 201 and the second position lamp LED 203 illuminate the position light guide 250. The position light guide 250 may be installed on an outer circumference of the side minor 1. Therefore, the first position lamp LED 201 and the second position lamp LED 203 may emit light in second and fourth directions which are different from the first direction. Specifically, when one position light guide 250 is used, the first position lamp LED 201 and the second position lamp LED 203 may emit light to both ends of the position light guide 250, respectively.

Alternatively, when one position light guide 250 is used, any one of the first position lamp LED 201 and the second position lamp LED 203 may emit light as described above. Furthermore when two position light guides 251 and 253 are used as shown in FIGS. 3 through 6, the first position lamp LED 201 and the second position lamp LED 203 may illuminate the first position light guide 251 and the second position light guide 253, respectively.

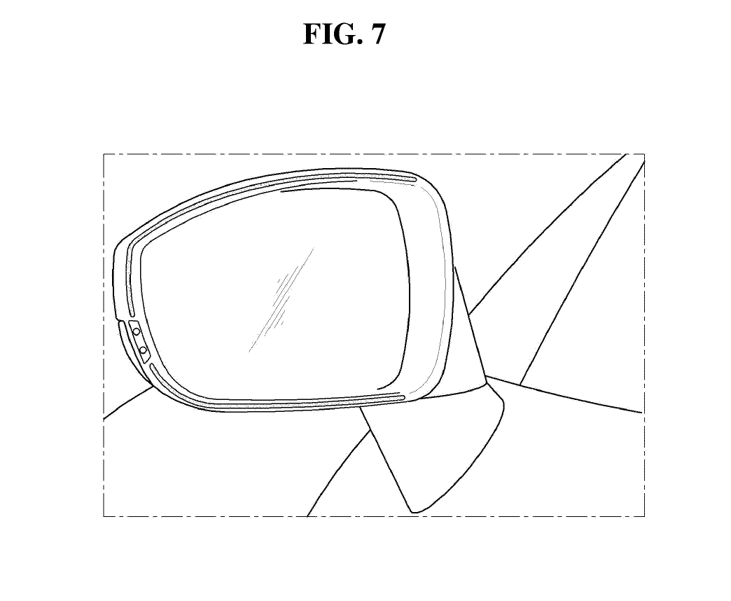

FIG. 7 shows the vehicle side mirror 1 illuminated by the integrated lamp device according to the embodiment of the present invention. When two position light guides 251 and 253 are used, the integrated lamp device, according to the current embodiment, may illuminate the vehicle side mirror 1 as shown in FIG. 7.

The turn signal lamp LED 300 may be designed to illuminate a turn signal lamp 30, mounted on an outside edge of the side minor 1. When a driver of the vehicle intends to make a turn, the turn signal lamp 30 illuminates, thereby informing drivers of other vehicles of the turning direction. In FIGS. 1 through 7, one turn signal lamp LED may be used. However, the number of turn signal lamp LEDs is not limited. The turn signal lamp LED 300 may emit light in a direction toward a side of the vehicle. This direction will be referred to as a third direction for ease of description.

The PCB assembly 400 may include a first PCB 401 on which the backup lamp LEDs 100 may be mounted, a second PCB 402 on which the first position lamp LED 201 may be mounted, and a third PCB 404 on which the turn signal lamp LED 300 may be mounted. In this embodiment, the first through third PCBs may be integrated with each other. In order words the first through third PCBs are structurally connected to each other or are made from one PCB. Furthermore, when the second position lamp LED 203 is also used, a fourth PCB 403 on which the second position lamp LED 203 may be mounted may be integrated with the first through third PCBs to form one PCB assembly 400.

The backup lamp LEDs 100, the first position lamp LED 201, the second position lamp LED 203, and the turn signal lamp LED 300 included in the integrated lamp device of the vehicle side minor 1 according to one embodiment may be structured to emit light in different directions. In particular, the PCB assembly 400 may have a 3-Dimensional (3D) structure such that the above three or four types of LEDs mounted on the PCB assembly 400 may emit light in different directions.

PCBs may be classified into rigid PCBs and flexible PCBs. As illustrated in FIGS. 3 through 6, multiple rigid PCBs may be connected to each other at predetermined angles. Although not shown in the drawings, the rigid PCBs may be connected to each other in various ways using, e.g., [symbol] -shaped sockets. Moreover, surfaces of the PCB assembly 400 respectively face toward the first through fourth directions. The PCBs whose respective surfaces face toward the first through fourth directions may be referred to as first through fourth rigid PCBs, respectively.

Referring to FIG. 5 or 6, the backup lamp LEDs 100 may be mounted on a first rigid PCB 401 whose surface faces toward the first direction, the first and second position lamp LEDs 201 and 203 may be mounted on second and fourth rigid PCBs 402 and 403 whose respective surfaces face toward the second and fourth directions, respectively, and the turn signal lamp LED 300 may be mounted on a third rigid PCB 404 whose surface faces toward the third direction.

When a flexible PCB is used, the PCB may be bent such that one or more surfaces of the bent flexible PCB face toward different directions (the first through fourth directions). Further, the backup lamp LEDs 100, the first position lamp LED 201, the turn signal lamp LED 300, and the second position lamp LED 203 may be mounted on the surfaces facing toward the first through fourth directions, respectively. Moreover, when necessary, a combination of rigid and flexible PCBs can be used. Although an embodiment using the flexible PCB is not described with reference to drawings, it may be fully inferred from the embodiment using the rigid PCBs described above with reference to FIGS. 3 through 6.

The second direction and the fourth direction are directions in which the first position lamp LED 201 and the second position lamp LED 203 may emit light toward the first and second position light guides 251 and 253, respectively. However, in one embodiment, any one of the first position lamp LED 201 and the second position lamp LED 203 may emit light in the second or fourth direction. When the first position lamp LED 201 and the second position lamp LED 203 emit light in two directions, the two directions may be different from each other. Accordingly, the second rigid PCB 402 and the fourth rigid PCB 403 may be arranged substantially parallel to each other as shown in FIGS. 2 through 6. Thus, the second direction and the fourth direction may be substantially opposite directions. The backup lamp LEDs 100 may be designed to emit light toward the rear of the vehicle. Therefore, the first direction may be substantially perpendicular to the second direction and the fourth direction. The turn signal lamp LED 300 may be structured to emit light toward a side of the vehicle. Therefore, the third direction may be substantially perpendicular to the second direction and the fourth direction and may be different from the first direction. Since the PCB assembly 400 may emit light in three or four different directions as described above, it may have a 3D structure.

The integrated lamp device of the vehicle side mirror 1 according to the embodiments of the present invention may further include the position light guide 250 which may emit light from the first position lamp LED 201 and the second position lamp LED 203. When one position light guide 250 is used as shown in FIG. 2, the position light guide 250 may receive light from the first position lamp LED 201 through an end thereof and may receive light from the second position lamp LED 203 through the other end thereof. Furthermore, when two position light guides 251 and 253 are used to illuminate the position lamp 20 as shown in FIG. 7, the guides may emit light from the first position lamp LED 201 and the second position lamp LED 203, respectively.

The first position lamp LED 201 and the second position lamp LED 203 may be substantially separated from the position light guide 250 or the first and second position light guides 251 as shown in FIGS. 3 through 6. However, the present invention is not limited thereto. The position light guide 250 and the two position light guides 251 and 253 may surround the outer circumference of the vehicle side mirror 1 to form the position lamp 20.

The integrated lamp device of the vehicle side mirror 1 according to the embodiments of the present invention may further include the turn signal light guide 350 which emits light from the turn signal lamp LED 300. Referring to FIGS. 3 through 5, the turn signal light guide 350 emits light which the turn signal lamp LED 300 shines in the third direction, thereby forming the turn signal lamp 30.

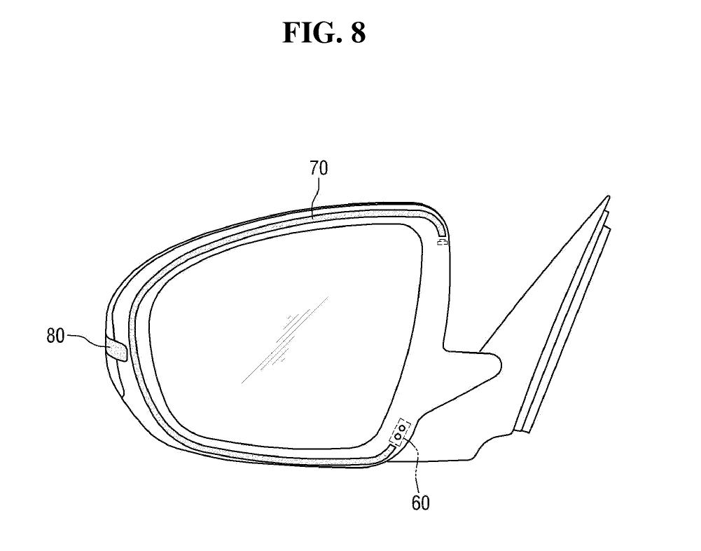

An integrated lamp device of a vehicle side mirror according to another embodiment of the present invention will now be described with reference to FIGS. 8 through 11.

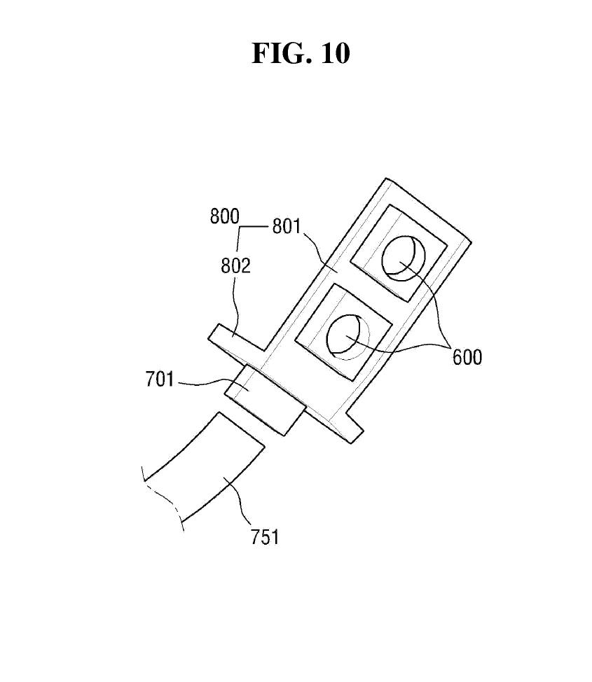

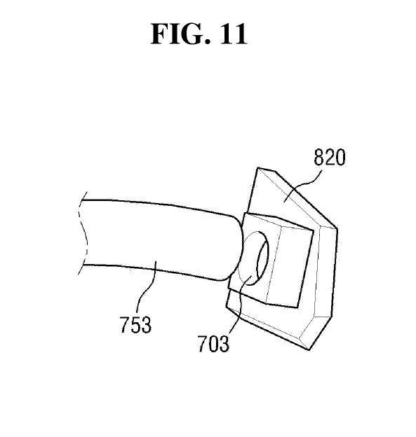

Referring to FIGS. 10 and 11, an integrated lamp device of a vehicle side mirror 2 according to another embodiment of the present invention may include backup lamp LEDs 600, a first position lamp LED 701, a PCB assembly 800, and a position light guide 751. The integrated lamp device may further include a third PCB 820 and a second position lamp LED 703.

FIGS. 8 through 11 are merely an embodiment suggested in the present invention, and the above light sources may be replaced with a light source for a different use. For example, the above light sources may be replaced with a puddle lamp light source. In particular, the puddle lamp light source may be one of the light sources suggested in FIGS. 8 through 11.

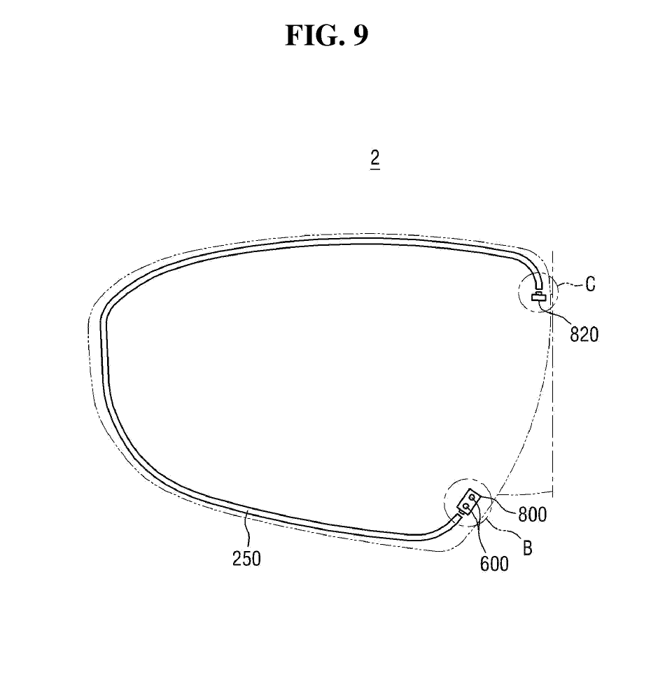

More specifically, a portion B of FIG. 9 may be disposed at a substantial distance from a vehicle allowing one of the backup lamp LEDs 600 to face downward. Therefore, the puddle lamp light source may be used as one PCB assembly, together with other lamps.

Unlike the embodiment of FIGS. 1 through 7 in which three types of lamps may be coupled to each other in a single structure, in the embodiment of FIGS. 8 through 11, three types of lamps may be substantially separated from each other while integrated into one vehicle side minor 2. In particular, in the current embodiment, the arrangement of the backup lamp LEDs 600 and the first and second position lamp LEDs 701 and 703 may be altered while a turn signal lamp 80 may be maintained as a separate structure.

The backup lamp LEDs 600 may emit light in a first direction toward the rear of the vehicle, and the first position lamp LED 701 may emit light in a second direction. In addition, the PCB assembly 800 may include a first PCB on which the backup lamp LEDs 600 may be mounted and a second PCB on which the first position lamp LED 701 may be mounted. Here, the first PCB and the second PCB may be integrated with each other. The position light guide 751 emits light from the first position lamp LED 701.

In the embodiment of FIGS. 1 through 7, the PCB assembly 400 may be disposed on an outer most edge (A) of the side minor 1. In the embodiment of FIGS. 8 through 11, the PCB assembly 800 can be disposed at any position on an outer circumference of the vehicle side minor 2. For example, referring to FIGS. 8 and 9, the PCB assembly 800 may be disposed on a lower outer circumference (B) of the side minor 2 substantially close to the driver. In addition, when the third PCB 820 and the second position lamp LED 703 are substantially separated from the PCB assembly 800, they may be disposed on an upper outer circumference (C) of the side minor 2 substantially close to the driver. The B and C positions may be interchanged with each other because the integrated lamp device of the vehicle side minor 2 may be designed such that three types of lamps may be separated from each other while integrated into one vehicle side minor 2.

The number of position light guides used in the embodiment of FIGS. 8 and 9 may be one or two. When one position light guide is used, the first position lamp LED 701 may emit light to an end of the position light guide. Moreover, when the second position lamp LED 703 is used together with the first position lamp LED 701, the second position lamp LED 703 may emit light to the other end of the position light guide. Furthermore, when two position light guides 751 and 753 are used, the first position lamp LED 701 and the second position lamp LED 703 may emit light to an end of the first position light guide 751 and an end of the second position light guide 753, respectively. The position light guides 751 and 753 may surround the outer circumference of the vehicle side minor 2 to form a position lamp 70.

The PCB assembly 800 may emit light in two different directions and thus it may have a 3D structure. In one embodiment, the surfaces of the first and second PCBs, which may form the PCB assembly 800 respectively, face toward the first and second directions and the rigid PCBs may be used as the first and second PCBs. Thus, the first and second PCBs whose respective surfaces may face toward the first and second directions may be referred to as first and second rigid PCBs, respectively.

Referring to FIG. 10, the backup lamp LEDs 100 may be mounted on a first rigid PCB 801 whose surface may face in the first direction, and the first position lamp LED 701 may be mounted on a second rigid PCB 802 whose surface may face in the second direction.

Moreover, when a flexible PCB is used, it may be bent such that one or more surfaces of the bent flexible PCB may face in different directions (the first and second directions). Then, the backup lamp LEDs 100 and the first position lamp LED 201 may be mounted on the surfaces that face in the first and second directions, respectively. Although an embodiment using the flexible PCB is not described with reference to drawings, it may be fully inferred from the embodiment using the rigid PCBs. When necessary, a combination of rigid and flexible PCBs may be used.

Other technical features are similar to those described above with reference to FIGS. 1 through 7, and thus a description of FIGS. 1 through 7 may be referred to.

In an integrated lamp device of a vehicle side mirror according to embodiments of the present invention, various types of lamps for various purposes and a light guide may be integrated into a single structure. Such efficient space utilization enables the lamps and the light guide to all be installed in the vehicle side mirror.

While the present invention has been particularly shown and described with reference to exemplary embodiments thereof, it will be understood by those of ordinary skill in the art that various modification, additions and substitutions are possible without departing from the spirit and scope of the present invention as disclosed in the accompanying claims. The exemplary embodiments should be considered in a descriptive sense only and not for purposes of limitation.

What is claimed is:

1. An integrated lamp device of a vehicle side mirror, the lamp device comprising:
a first light source illuminating a first direction;
a second light source illuminating a second direction; and
a printed circuit board (PCB) assembly including a first PCB on which the first light source is mounted and a second PCB on which the second light source is mounted, wherein the first PCB and the second PCB are integrated with each other.

2. The lamp device of claim 1, further comprising:
a third light source illuminating a third direction; and
a fourth light source illuminating a fourth direction,
wherein the third light source is mounted on a third PCB, the fourth light source is mounted on a fourth PCB, and the PCB assembly includes the first through fourth PCBs integrated with each other.

3. The lamp device of claim 2, wherein each of the first through fourth light sources is one light source selected from the group consisting of a backup lamp light source, a turn signal lamp light source, a position lamp light source, and a puddle lamp light source.

4. The lamp device of claim 3, wherein the backup lamp light source is mounted on the first PCB, a first position lamp light source is mounted on the second PCB, the turn signal lamp light source is mounted on the third PCB, and a second position lamp light source is mounted on the fourth PCB.

5. The lamp device of claim 3, wherein the puddle lamp light source is mounted on the first PCB and is configured to illuminate a downward direction.

6. The lamp device of claim 3, wherein the PCB assembly includes at least one flexible PCB.

7. The lamp device of claim 3, wherein the second direction and the fourth direction are substantially opposite directions, the first direction and the third direction are substantially perpendicular to the second direction and the fourth direction, and the third direction and the first direction are substantially different directions.

8. The lamp device of claim 3, further comprising a light guide receiving light through an end thereof from at least one of the light sources.

9. The lamp device of claim 4, further comprising:
a first position light guide emitting light from the first position lamp light source; and
a second position light guide emitting light from the second position lamp light source.

10. The lamp device of claim 8, wherein the light guide surrounds a substantial part of an outer circumference of the vehicle side mirror.

11. The lamp device of claim 3, further comprising a turn signal light guide emitting light from the turn signal lamp light source.

12. An integrated lamp device of a vehicle side mirror, the lamp device comprising:
a first light source illuminating a first direction;
a second light source illuminating a second direction;
a PCB assembly comprising a first PCB on which the first light source is mounted and a second PCB on which the second light source is mounted; and
a first light guide receiving light through an end thereof from at least one of the first and second light sources,
wherein the first PCB and the second PCB are integrated with each other.

13. The lamp device of claim 12, further comprising:
a third PCB substantially separated from the PCB assembly; and
a third light source mounted on the third PCB,
wherein the third light source emits light to the other end of the light guide.

14. The lamp device of claim 13, wherein each of the first through third light sources is one light source selected from the group consisting of a backup lamp light source, a turn signal lamp light source, a position lamp light source, and a puddle lamp light source.

15. The lamp device of claim 12, further comprising a second light guide, wherein the first and second light guides surround a substantial part of an outer circumference of the vehicle side mirror.

16. The lamp device of claim 15, further comprising:
a third light source emitting light to an end of the second light guide; and
a third PCB substantially separated from the PCB assembly,
wherein the third light source is mounted on the third PCB.

17. The lamp device of claim 12, wherein the PCB assembly comprises at least one flexible PCB.
